(19) United States
(12) Patent Application Publication
(10) Pub. No.: US 2022/0126384 A1
(43) Pub. Date: Apr. 28, 2022

(54) METHOD FOR GRINDING OR POLISHING A GEARWHEEL OR A WORKPIECE WITH A GEARWHEEL-LIKE PROFILE IN A GRINDING OR POLISHING MACHINE

(71) Applicant: KAPP NILES GMBH & CO. KG, Coburg (DE)

(72) Inventors: Frank MÜLLER, Meeder (DE); Friedrich WÖLFEL, Coburg (DE)

(21) Appl. No.: 17/430,576

(22) PCT Filed: Feb. 22, 2020
(86) PCT No.: PCT/EP2020/054707

§ 371 Date: Aug. 12, 2021

(30) Foreign Application Priority Data
Feb. 26, 2019 (DE) 10 2019 104 812.5

(51) Int. Cl. B23F 5/04; B23F 23/12

(52) U.S. Cl. CPC B23F 5/04; B23F 23/1218

(57) ABSTRACT

A method for grinding or polishing a gearwheel in a grinding or polishing machine, wherein the machine has two workpiece spindles for receiving a workpiece and a grinding or polishing spindle with a grinding or polishing tool. The method has the steps of: a) Grinding or polishing a first workpiece on a workpiece spindle; b) In a temporally parallel manner to the grinding or polishing of the first workpiece: Receiving a second workpiece on the further workpiece spindle and measuring the toothing of the workpiece to determine the positions of the tooth gaps, the measurement including scanning the tooth or profile flanks of at least one tooth by a tactile measuring element or by contactless measuring, in order to determine the effective oversize on the tooth flanks; c) Following completion of grinding or polishing the first workpiece: Grinding or polishing the second workpiece on the further workpiece spindle based on the determined positions of the tooth gaps and/or the measured effective oversize on the tooth.

The invention relates to a method for grinding or polishing a gearwheel or a workpiece with a toothing-like profile in a grinding or polishing machine, wherein the grinding or polishing machine comprises at least two workpiece spindles for receiving a workpiece and at least one grinding or polishing spindle with a grinding or polishing tool.

Grinding machines with more than one workpiece spindle are known in the state of the art. They have the advantage of being able to considerably reduce the non-productive times during machining. The loading and unloading of a workpiece on the other workpiece spindle can then take place temporally parallel with the machining of a workpiece on one workpiece spindle. After loading, the workpiece is aligned and centered on a second workpiece spindle, i.e. the position of the tooth gaps or profile gaps of the prefabricated workpiece, e.g. in the form of a gear wheel, is determined so that the grinding tool can then enter the gap in a targeted manner during the actual grinding operation.

The cycle time of the process determines how long the loading, unloading and alignment of the workpiece may take.

For this reason, a non-contact inductive sensor is usually used to detect the position of the tooth gaps or profile gaps, which sensor can quickly scan the circumference of the toothing or profiling in order to determine where the gaps are in which the grinding tool must enter. Such a sensor can therefore detect the gap centers of a gear or similar profile by means of the detectable switching signals and thus draw conclusions about the distortion due to hardening and the position of the workpiece on the workpiece spindle.

With such a solution, however, it is not possible to determine the actual stock allowance on the flanks of the toothing or profile.

When the process of grinding is referred to herein and hereinafter, the alternative process of polishing is also to be understood, for which the present invention can be applied in the same way.

The invention is based on the object of further developing a process of the type mentioned above in such a way that it is possible to obtain improved information about the workpiece to be ground or polished in a time-neutral manner and without the use of external measuring systems, and thus to optimize the grinding or polishing process. This means that improved grinding or polishing results should be achieved without additional processing times and without the use of external measuring systems.

The solution of this object provides according to the invention that the method comprises the steps of:
a) Grinding or polishing of a first workpiece received on a workpiece spindle;
b) In a temporally parallel manner to the grinding or polishing of the first workpiece:

Receiving a second workpiece on the further workpiece spindle and measuring the toothing or the toothing-like profile of the workpiece in order to determine the position of the tooth gaps or profile gaps, wherein the measurement of the toothing or the toothing-like profile comprises scanning of the tooth or profile flanks of at least one tooth or profile gap by means of a tactile measuring element or a contactless measuring device, in order to determine the effective oversize on the tooth or profile flanks;
c) After completion of the grinding or polishing of the first workpiece: Grinding or polishing of the second workpiece received on the further workpiece spindle using the determined position of the tooth gaps or profile gaps and/or the measured effective oversize on the tooth or profile flank as a basis.

When performing step b) above, a plurality of tooth or profile gaps can also be scanned; in particular, all tooth or profile gaps can be scanned.

The measurement according to step b) above is preferably initially carried out by means of a measuring probe. Alternatively, however, it is also possible for the measurement to be carried out by means of a laser.

A preferred embodiment of the method provides that the grinding or polishing according to above step c) is carried out by specifying grinding or polishing parameters which take into account the actual oversize on the tooth or profile flanks. Thereby, the influenced parameter can be the feed speed between grinding or polishing tool and workpiece and/or the number of grinding or polishing strokes and/or the amount of infeed of the grinding or polishing tool to the workpiece.

After grinding according to above step c), the ground or polished toothing or the toothing-like profile of the workpiece can be measured again.

The tactile measuring element or the contactless measuring device can be arranged on a linear slide with which it can be moved and positioned in a translatory direction.

In addition, an inductive sensor can also be arranged in the grinding or polishing machine, with which the position of the tooth gaps or profile gaps are determined.

The proposed concept thus allows an effective determination of the actual present allowance as well as distortion due to hardening before machining.

Thus, temporally parallel to the machining of a workpiece on the first workpiece spindle, a workpiece to be machined on the second workpiece spindle is measured with a probe or a non-contact measuring element, the tooth or profile gap is found and the existing allowance and the distortion due to hardening are determined.

Typically, the two workpiece spindles are permanently arranged in the machine tool, whereby a partition wall can be brought between them, if necessary, in order to create two separate partial spaces and thus keep the cooling lubricant away from the spindle on which grinding is not currently taking place. However, it is also possible that the workpiece spindles or at least workpiece holders can be removed from the machine by means of a handling system and reinserted into it, so that the measurement or centering mentioned takes place outside the machine.

The invention takes advantage of the fact that sometimes sufficient time remains on the other workpiece spindle during the grinding or polishing operation so that the actual allowance can be recorded.

Advantageously, the proposed procedure, which allows much better positioning of the workpiece relative to the grinding or polishing tool, eliminates the need for a two-flank rolling test rig, which is otherwise frequently used for quality assurance.

Furthermore, it is possible to optimize the grinding or polishing process individually for each workpiece to be processed by specifying optimally adapted grinding or polishing parameters depending on the previously determined effective oversize for grinding or polishing.

If the cycle time is sufficiently long, the finished ground or polished workpiece can be measured again by means of the measuring probe or the non-contact measuring element before it is unloaded in order to detect any deviations that may exist, namely a deviation between the ideal position of the toothing or profile on the base body of the workpiece and the geometry of the workpiece resulting from the hardening distortion or actual allowance. By evaluating such systematic deviations, it is possible to work with corrected settings, if necessary, and thus optimize the grinding or polishing process in a closed control loop.

The proposed procedure makes it possible to determine the effective allowance of the workpiece to be machined with little effort and without extending the machining times. Knowing this, the grinding or polishing process can then be optimized.

The use of the proposed measuring probe or non-contact measuring element generally replaces the inductive sensor otherwise used up to now and additionally offers the possibility of detecting the actual flank allowance of at least one, preferably a number and particularly preferably all gaps.

However, it is also possible that the inductive sensor is additionally used in order to realize a further optimized process sequence in combination of the sensor with the measuring probe or the non-contact measuring element. In this case, it can be provided that the tactile probe or the non-contact measuring element measures only a single gap and thus the allowance is detected so that the workpiece can be aligned or centered on the basis of this gap. The inductive sensor could then additionally measure all other teeth or gaps, so that an improved statement about the complete workpiece can be made with the reference gap already measured by the touch probe and the determined allowance as well as the further information of the inductive sensor.

The tactile measuring element (in particular the probe) or the non-contact measuring element is preferably positioned via a linear axis of the grinding machine. After calibrating the probe by means of a reference body of known geometry (e.g. a ball with a known diameter), the probe can be moved to the required position by means of the linear axis.

The measured values of the probe or the non-contact measuring element are recorded by the machine control system and processed in a known manner in order to find the optimum center position of the workpiece relative to the grinding tool with regard to the toothing or profile.

In the drawings an embodiment of the invention is shown.

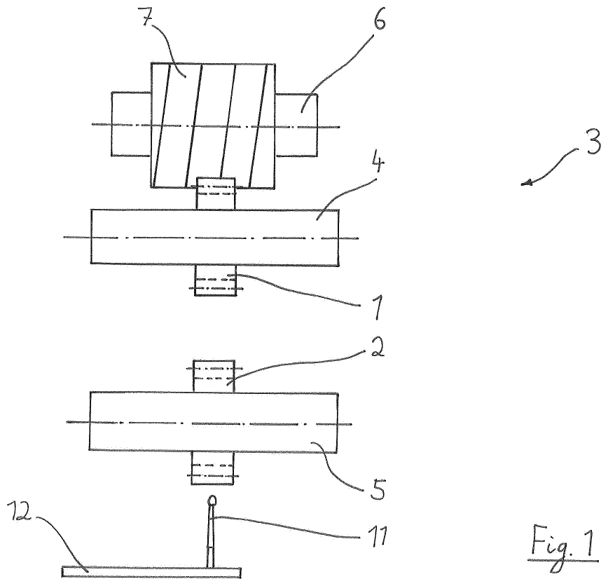

FIG. 1 shows a schematic depiction of a grinding machine with two workpiece spindles and one grinding spindle with a grinding tool and

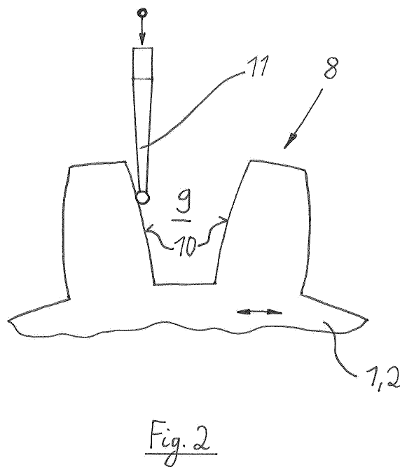

FIG. 2 shows schematically the measurement of a tooth gap by means of a measuring sensor.

FIG. 1 shows only very schematically a grinding machine 3 equipped with two workpiece spindles 4 and 5 and a grinding spindle 6. On the two workpiece spindles 4 and 5, in the embodiment, a workpiece 1 or 2 can be held (clamped) in each case. A grinding tool 7 in the form of a grinding worm is arranged on the grinding spindle 6.

As can be seen from the synopsis with FIG. 2, the workpieces 1, 2 in this case are toothed wheels which have a toothing 8. However, the following considerations apply equally if another workpiece with a toothing-like profile is machined instead of a gear.

In principle, the actual grinding is performed by means of the grinding worm 7 by grinding the workpiece 1 on one of the two workpiece spindles 4, while preparatory actions for grinding are performed on the other workpiece spindle 5. These include first clamping the workpiece 2 on the workpiece spindle 5 and then aligning or centering it. The pre-machined (for example by hobbing) workpiece 1, 2 with its toothing 8 must be positioned relative to the grinding worm 7 in such a way that the abrasive surfaces of the grinding worm engage in the tooth gaps 9 of the toothing 8 (see FIG. 2).

The grinding process then removes an oversize from the respective tooth flanks 10 by the grinding tool 7.

For this purpose, it is provided that during the grinding of one workpiece 1 on one workpiece spindle 4, the workpiece 2 on the other workpiece spindle 5 is subjected temporally parallel to a measuring process by means of a measuring element 11, as shown schematically in FIG. 2.

At least in one tooth gap 9, the two opposing tooth flanks 10 are measured by probing to determine the effective oversize of the toothing. For this purpose, the probe 11 is placed on a linear slide 12 so that it can be moved to the required measuring position. FIG. 2 shows with arrows how the measuring probe 11 is moved radially relative to the toothing 8, furthermore the workpiece is rotated back and forth in the circumferential direction in order to measure pointwise the contour of the tooth flank 10 to be ground.

On the basis of the measured oversize of at least one, preferably a plurality and particularly preferably all of the tooth gaps 9, it is thus possible to determine the optimum centering position of the workpiece 2 relatively to the grinding worm 7, so that ideally an equal amount of material is removed from the two opposing tooth flanks 10.

Such an optimization of the grinding process is only possible to a limited extent if, according to the state of the art, only the position of the tooth spaces is detected by means of an inductive sensor and the workpiece is centered on this basis. In this case, there is namely no information about the actual oversize.

Measuring by means of a probe in the manner described requires more time than centering by means of an inductive sensor, but in many cases this time is available until the workpiece, which has been ground temporally parallel, is finished.

Depending on the values recorded for the effective oversize, it is then possible, in a further development of the proposed method, to adjust the production parameters in order to optimize the grinding process. In particular, it is intended to change or adjust the feed speed between the grinding tool 7 and the workpiece 1, 2. Likewise, it can be considered to adjust the number of grinding strokes or the size of the infeed of the grinding tool 7 to the workpiece 1, 2. The volume of stock removed over time can thus be kept within a desired range and, in particular, constant.

While the workpiece 2 is being ground, the finished workpiece 1 is removed temporally parallel on the other tool spindle and the next workpiece is clamped and measured in the manner described. Thus, workpieces are ground alternately on the two workpiece spindles. The described process of determining the allowance therefore takes place alternately on the two workpiece spindles, in each case parallel to the main machining time.

### REFERENCE NUMERALS

1 Workpiece (gear wheel)
2 Workpiece (gear wheel)
3 Grinding machine/polishing machine
4 Workpiece spindle
5 Workpiece spindle
6 Grinding spindle
7 Grinding tool (grinding worm)
8 Toothing/toothing-like profile
9 Tooth gap/profile gap
10 Tooth flank/profile flank
Tactile measuring element (measuring sensor)/contactless measuring device (laser)
12 Linear slide

1-10. (canceled)

11. A method for grinding or polishing a gearwheel or a workpiece with a toothing-like profile in a grinding or polishing machine, wherein the grinding or polishing machine comprises at least two workpiece spindles for receiving a workpiece and at least one grinding or polishing spindle with a grinding or polishing tool, wherein
the method comprises the steps of:
a) Grinding or polishing of a first workpiece received on a workpiece spindle;
b) In a temporally parallel manner to the grinding or polishing of the first workpiece: Receiving a second workpiece on the further workpiece spindle and measuring the toothing or the toothing-like profile of the workpiece in order to determine the position of the tooth gaps or profile gaps, wherein the measurement of the toothing or the toothing-like profile comprises scanning of the tooth or profile flanks of at least one tooth or profile gap by means of a tactile measuring element or a contactless measuring device, in order to determine the effective oversize on the tooth or profile flanks;
c) After completion of the grinding or polishing of the first workpiece: Grinding or polishing of the second workpiece received on the further workpiece spindle using the determined position of the tooth gaps or profile gaps and/or the measured effective oversize on the tooth or profile flank as a basis.

12. The method according to claim 11, wherein a plurality of tooth or profile gaps are scanned when performing step b).

13. The method according to claim 11, wherein all tooth or profile gaps are scanned when performing step b).

14. The method according to claim 11, wherein the measurement according to step b) is carried out by means of a measuring sensor.

15. The method according to claim 11, wherein the measurement according to step b) is performed by means of a laser.

16. The method according to claim 11, wherein the grinding or polishing according to step c) is carried out by specifying grinding or polishing parameters which take into account the actual oversize on the tooth or profile flanks.

17. The method according to claim 16, wherein the influenced parameter is the feed speed between grinding or polishing tool and workpiece and/or the number of grinding or polishing strokes and/or the amount of infeed of the grinding or polishing tool to the workpiece.

18. The method according to claim 11, wherein after grinding or polishing according to step c), the ground or polished toothing or the toothing-like profile of the workpiece is measured again.

19. The method according to claim 14, wherein the tactile measuring element or the contactless measuring device is arranged on a linear slide with which it can be moved and positioned in a translatory direction.

20. The method according to claim 11, wherein an inductive sensor is additionally arranged in the grinding or polishing machine, with which the position of the tooth gaps or profile gaps are determined.
